(19) United States
(12) Patent Application Publication
(10) Pub. No.: US 2024/0269568 A1
(43) Pub. Date: Aug. 15, 2024

(54) GAME SERVER, GAME PROGRAM, INFORMATION PROCESSING METHOD

(71) Applicant: Akatsuki Inc., Tokyo (JP)

(72) Inventor: Qianwen HUANG, Tokyo (JP)

(21) Appl. No.: 18/570,041

(22) PCT Filed: Feb. 25, 2022
(86) PCT No.: PCT/JP2022/008020

§ 371 Date: Dec. 13, 2023

(30) Foreign Application Priority Data
Jun. 14, 2021 (JP) 2021-098416

(51) Int. Cl. A63F 13/69

(52) U.S. Cl. CPC A63F 13/69

(57) ABSTRACT

An exemplary game server comprises a group information management unit that manages one or more values of one or more parameters associated with a group that includes a plurality of players; and a privilege granting unit that when the one or more values of the one or more parameters satisfies a predetermined conditions, grants predetermined in-game privileges only to one or more players that have performed actions that satisfy the predetermined conditions, in the group associated with the one or more parameters.

### TECHNICAL FIELD

The present disclosure relates to a game server, a game program, and an information processing method.

### BACKGROUND ART

There are commonly known configurations of granting benefits or privileges to players who log in games provided in smart phones and so on, as measures of prompting the players to continuously log in the games.

Patent literature 1 discloses a game system that grants players prescribed benefits when the players or their friends log in games.

### PRIOR ART LIST

### Patent Literature

Patent Literature 1: Japanese Examined Patent Publication No. 5080673

### SUMMARY OF THE INVENTION

### Technical Problem

The literature above includes a general description that the players are granted points or items allowing the players to advantageously play the games as the benefits of logging in the games.

However, the configuration, which grants the players the prescribed benefits as compensation for the players' continuous logging in the games, leads the interest of the players to whether or not the players are granted the benefits when logging in, thereby to fail in stimulating incentive of the players to continue playing the games after logging in.

Accordingly, an object of the present disclosure is to provide a game server, a game program, and an information processing method capable of providing a new configuration that gives the players incentive of continuously playing the game.

### Technical Solution

According to the present disclosure, there are provided a game server, a game program, and an information processing method that comprise a group information management unit that manages one or more values of one or more parameters associated with a group that includes a plurality of players; and a privilege granting unit that when the one or more values of the one or more parameters satisfies a predetermined conditions, grants predetermined in-game privileges only to one or more players that have performed actions that satisfy the predetermined conditions, in the group associated with the one or more parameters.

### Advantageous Effects

According to the present disclosure, there are provided a game server, a game program, and an information processing method capable of providing a new configuration that gives the players incentive of continuously playing the game.

### BRIEF DESCRIPTION OF THE DRAWING

FIG. 1 shows an example of the configuration of a system of an embodiment according to the present disclosure.

FIG. 2: is a functional block diagram of a server device in FIG. 1.

FIG. 3: shows an example of a data configuration of a character owned according to the present disclosure.

FIG. 4 shows an example of a group information table stored in a group information storage unit in FIG. 2.

FIG. 5 shows an example of privilege information stored in a privilege information storage unit in FIG. 2.

FIG. 6 shows a functional block diagram of a player terminal in FIG. 1.

FIG. 7 shows an example of a flowchart of a method granting privileges according to an embodiment of the present disclosure.

FIG. 8 shows an example of a screen of a player terminal according to an embodiment of the present disclosure.

### DETAILED DESCRIPTION OF THE EMBODIMENTS

The contents of embodiments of the present disclosure will be listed and described.

The present disclosure has the following configurations.

### [Item 1]

A game server comprising:
a group information management unit that manages one or more values of one or more parameters associated with a group that includes a plurality of players; and
a privilege granting unit that when the one or more values of the one or more parameters satisfies a predetermined conditions, grants predetermined in-game privileges only to one or more players that have performed actions that satisfy the predetermined conditions, in the group associated with the one or more parameters.

### [Item 2]

The game server according to item 1, wherein the group information management unit updates the one or more parameters in common in the group based on a behavior of one of the plurality of players in the group

### [Item 3]

The game server according to item 1, wherein the predetermined condition includes that a sum of the one or more values of the one or more parameters of each of the plurality of players in the group reaches a predetermined value.

### [Item 4]

The game server according to item 3, wherein the privilege granting unit grants the predetermined in-game privileges to a predetermined number of the plurality of players in order of their contribution to a sum of the one or more values of the one or more parameters.

### [Item 5]

The game server according to item 1, wherein the predetermined conditions, the predetermined in-game privileges, and the one or more players that are granted the predetermined in-game privileges are set individually for each of the one or more parameters.

### [Item 6]

A game program that allows a computer to implement:
managing one or more values of one or more parameters associated with a group that includes a plurality of players; and
when the one or more values of the one or more parameters satisfies a predetermined conditions, granting predetermined in-game privileges only to one or more players that have performed actions that satisfy the predetermined conditions, in the group associated with the one or more parameters.

### [Item 7]

An information processing method by using a computer, comprising:
managing one or more values of one or more parameters associated with a group that includes a plurality of players; and
a privilege granting unit that when the one or more values of the one or more parameters satisfies a predetermined conditions, granting predetermined in-game privileges only to one or more players that have performed actions that satisfy the predetermined conditions, in the group associated with the one or more parameters.

Hereinafter, the embodiments of the present disclosure will be described with reference to the drawings.

### <Configuration>

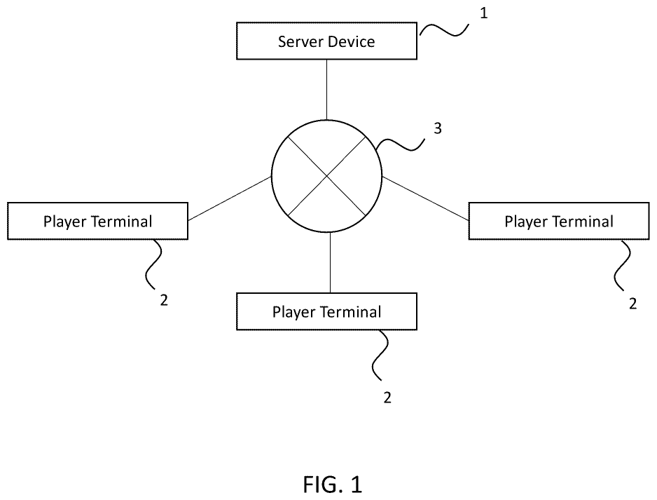

FIG. 1 is a diagram showing a configuration example of a system according to an embodiment of the present disclosure. As shown in FIG. 1, the game system provides various services relating to games to players via a network 3 (for example, the Internet), and has a server device 1 (a game server) and a plurality of player terminals 2.

### <Configuration of Server Device 1>

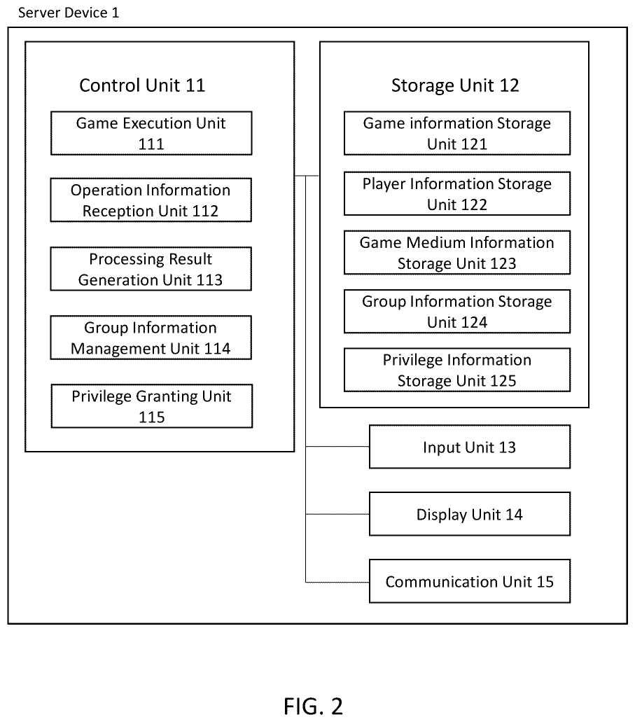

FIG. 2 is a functional block diagram of the server device 1 shown in FIG. 1. The server device 1 is an information processing device (a computer) used by a system administrator or the like to manage and control various services, and may be, for example, a general-purpose computer such as a workstation or a personal computer, or may be logically realized by cloud computing technology.

The server device 1 has a control unit 11, a storage unit 12, an input unit 13, a display unit 14 and a communication unit 15. The server device 1 executes processing by the game program in the control unit 11, when receiving various commands (requests) from the player terminal 2 via the communication unit 15, and transmits the processing result of the game program (e.g., game image, game sound, etc.) to the player terminal 2. Further, a part of the game program may be transmitted to the player terminal 2 and executed in the player terminal 2.

The control unit 11 transfers data between units and, at the same time, controls the entire server device 1, which are realized by executing a program stored in a predetermined memory by a CPU (Central Processing Unit) or a GPU (Graphics Processing Unit). The control unit 11 of the present embodiment includes at least a game execution unit 111, an operation information reception unit 112, a processing result generation unit 113, and a group information management unit 114, and a privilege granting unit 115.

The game execution unit 111 has a function of executing a process for progressing the game in accordance with the game program. The game by the game system in the present embodiment may be any type of game, and examples thereof may be a battle game, a puzzle game, an action game, a baseball game, a soccer game, other sports games, a quiz game, a pinball game, a card game, a rhythm game, an RPG, an adventure game, a casino game, a simulation game, a strategy game, a board game, and a racing game.

In the games, events may be held regularly or irregularly. The events may be any type of events that occur in the games, and examples thereof may be a game event such as a quest game having plural conventional stages and a stage game having a independent stage; a lottery game for acquiring a game medium by using a paid or free in-game currency; and a training game for enhancing parameters of owned characters (for example, raising the level thereof). A body or mass of plural players that participate in such events is also an instance of a “group”, which will be described later in the embodiment.

In the games, battle events called raids may be held regularly or irregularly. The raids are generally battle events, in which plural players fight together against a strong enemy such as a boss character. Such raids are initiated, for example, when a player calls his/her friend or a guild member to gather plural players in the game. A body or mass of plural players gathered in such raids is also an instance of a “group”, which will be described later in the embodiment.

The operation information reception unit 112 receives the operation information transmitted from the player terminal 2. The received operation information is used as instruction information for processing the game program by the game execution unit 111.

The processing result generation unit 113 has a function of executing processing for generating the processing result of the game program executed by the game execution unit 111. The generated processing result is transmitted to the player terminal 2 by the processing result generation unit 113 and is outputted by the output unit 24, which will be described later. Furthermore, the processing result generation unit 113 has a function of updating the player information stored in the player information storage unit 122 or the game medium information stored in the game medium information storage unit 123, if there is any change in the player information or the game medium information stored in the storage units 122, 123 as a generated result of the processing.

The group information management unit 114 detects, for each of one or more groups, based on the IDs of the plural players belonging to each group, whether or not there is any change in the player information stored in the player information storage unit 122 associated with the IDs, and if there is detected such a change, updates the group information stored in the group information storage unit 124. Details of the processing by the group information management unit 114, and details of both the player information stored in the player information storage unit 122 and the group information stored in the group information storage unit 124, are described later. The groups are composed of units such as teams (guilds) including plural players in a sports game, a combat game, and a quest game; pairs including two players; and regions where players are located (city, town, prefecture, Kanto region and other regional divisions, counties, states, countries, continents, etc.). It is also possible to consider all players as one group. Thus, each group is basically composed of plural players; however, there may be a group composed of only one player from the beginning, or a group composed of only one player after several players leave the group during the game, where the one player composes the group. The players composing the group may also include human players who operate the player terminals 2 to play the games, and virtual players who participate in the games under operation by the control unit 11, such as “non-player characters (NPCs)” or “CPUs.” If such virtual players are stored to be assigned the player IDs and to be associated with a certain group in the player information stored in the player information storage unit 122, the virtual players can also be treated as the players belonging to the group in the game system.

When each group meets the predetermined conditions of a parameter, the privilege granting unit 115 performs the process of granting the privilege associated with the parameter, according to the predetermined settings in the privilege information in the privilege information storage unit 125. The privilege granting unit 115 can set as the person eligible for the privilege, only one player of the group that yielded the factor satisfying the predetermined conditions; the top several players of the group that highly contributed to the factor satisfying the predetermined conditions; or all players of the group.

The predetermined conditions are, for example, as below:
(1) the total value of the parameters of each player in the group reaches the predetermined threshold value, and
(2) the value of the parameters of each group reaches the predetermined threshold value.

Herein, the parameters of each player belonging to a group may include, for example, each player's level, number of owned characters, number of owned items, number of acquired items, number of consumed items, amount of paid or free in-game currency held, amount of paid or free in-game currency consumed, number of owned points, number of acquired points, charged amount, number of performed lottery, total playing time, number of times of defeating enemies, and number of transferring items, points, or paid or free in-game currency to players in the same group, which are not limited thereto. The parameters of each group can include the number of items owned as the group, the number of items acquired as the group, and the number of battles and victories against other groups as the group, which are not limited thereto.

The objects to be counted (updated) by the group information management unit 114 as the above parameter value may be either the parameter values increased during the normal progress of the game (for example, the number of items acquired during normal stage play), and the parameter values increased during game events and raids (for example, the number of items acquired during special stage play), or both of them. In particular, if the parameter values increased during game events and raids are counted to provide privilege, game players may be motivated to join one of the groups and participate in events and raids to win the privilege, thereby yielding an effect of attracting customers to the events and raids in the game.

The privilege granting unit 115 is configured to judge, based on the group information table stored in the group information storage unit 124, whether or not the predetermined condition set for each parameter of each group has been met (whether or not a predetermined threshold has been met), and if the condition has been met, to execute a process to grant a predetermined privilege to a predetermined target person by referring to the privilege information stored in the privilege information storage unit 125. The privileges granted by the privilege granting unit 115 are mainly benefits advantageous to the player's progress in the game, which includes, for example, increasing the value of at least one of the player's parameters. Examples of privileges include increasing the player's level, increasing the number of owned items, acquiring special characters and items, and increasing the number of available lotteries, which are not limited thereto.

The privilege granting unit 115 is further configured to notify that granting the privileges has been completed after executing the process of granting the privileges to the predetermined target person. The target persons to be notified can be appropriately set, such as only a person granted the privileges, or all persons of the group. The contents of the notification are displayed on the output unit 24 (display device) of the player terminal 2 of the player who received the notification.

The storage unit 12 has a non-volatile storage device that is a read-only storage area in which a system program is stored, and a volatile storage device that is a rewritable storage area used as a work area for arithmetic processing by the control unit 11. The non-volatile storage device is realized by, for example, a ROM (Read Only Memory), a flash memory, a hard disk, or the like, and the volatile storage device is realized by RAM (Random Access Memory), VRAM (Video Random Access Memory), or the like. The storage unit 12 in the present embodiment has various storage units including at least a game information storage unit 121, a player information storage unit 122, a game medium information storage unit 123, a group information storage unit 124, and a privilege information storage unit 125.

The game information storage unit 121 stores information relating to the game. The game information is appropriately configured according to the type of game. For example, in the case of a game including a quest game, the stage name, enemy character information, consumption stamina information, and the like are included in association with the stage ID.

The player information storage unit 122 stores information relating to the player. The player information can include player name, owned character information, play stage information, owned item information, and player's location, being associated with the player ID. The owned character information can include the current values of various parameters, such as level, attack power, defense power, and strength, being associated with the owned character's ID. The play stage information is information on the stages that the player has played so far among the plural stages set, and can include the number of times played, and clear information. The owned item information can include information on the ownership status of one or more paid or free items, and can include information such as the number of owned items, being associated with the ID of each owned item. The player's location information can include information on the region (city, prefecture, regional division such as Kanto region, county, state, country, continent, etc.) in which the player resides, for example. Other information on the player and game play status may be included.

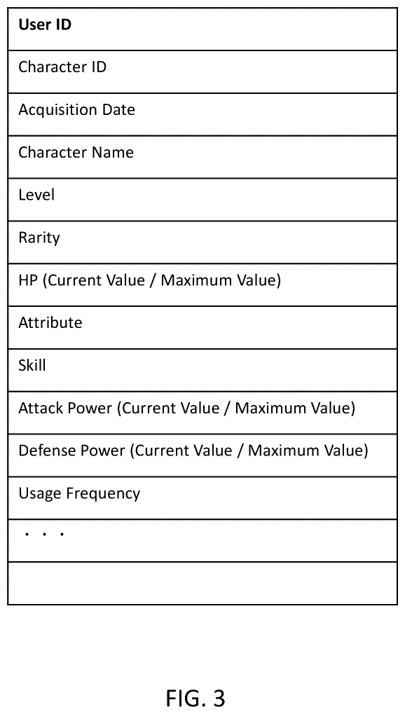

The game medium information storage unit 123 stores game medium information such as characters and items owned by the player. FIG. 3 is a diagram which shows a data configuration example relating to owned characters in the game medium information storage unit 123. The owned character information may include values of various parameters such as acquisition date and time, a character name, level, rarity, HP (current value/maximum value), an attribute, a skill, an attack power (current value/maximum value), a defense power (current value/maximum value), a usage frequency, in association with the ID of each owned character. The acquisition date and time are information related to the date and time when the character was assigned to the player as a result of the progress of the game or the execution of the lottery. The rarity is information relating to the probability of winning, for example, in a lottery game of the character. The HP, attack power, and defense power may include both the “current value” which is the current value, and the “maximum value” when the character is raised to the maximum level. The attribute is setting information related to classifications indicating the character's strengths, such as fire attribute, water attribute, or wind attribute for battle games, and classifications indicating his/her assigned team or position in a sports game, and other character classifications. The skill is information such as a special skill that the character can use. The usage frequency is information relating the frequency in which the player has selected or used the character in the past. The usage frequency may be calculated over the entire period since the player started the game or may be calculated over any period such as the last few months. Further, the game medium information may include information relating to owned items in addition to owned characters. The owned item information may include information such as the number of owned items in association with the ID of the owned item.

The group information storage unit 124 stores information on each group. The information on each group includes, for example, the player IDs of all players in each group, the total number of parameters for each player in each group, and the total number of parameters for each group. The parameters of players belonging to each group include, for example, as described above, each player's level, number of characters owned, number of items owned, number of items acquired, number of items consumed, amount of paid or free in-game currency possessed, amount of paid or free in-game currency consumed, number of points owned, number of points acquired, amount charged, number of lotteries executed, total play time, number of times the player has defeated enemies, and number of times the player has transferred items, points, paid or free in-game currency to players in the same group. The parameters of each group include, for example, the number of items owned by the group, the number of items acquired by the group, and the number of battles and victories to other groups, as described above.

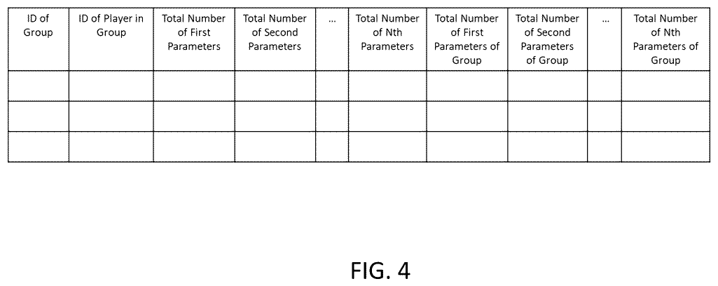

FIG. 4 shows an example of the configuration of information stored in the group information storage unit 124.

As an example, as shown in FIG. 4, the group information on the status of each group stored in the group information storage unit 124 may include below:
(1) ID of the group,
(2) ID of each player in the group,
(3) the total number of the first parameters (e.g., the number of characters owned by each player) of each player in the group and its log information,
(4) Total number of the second parameters (e.g., the number of items owned by each player) of each player in the group and its log information,
(5) The total number of the nth parameters (e.g., the amount of in-game currency spent by each player) of each player in the group and its log information,
(6) The total number of the first parameters of the group (e.g., the number of items owned by the group) and its log information,
(7) Total number of the second parameters of the group (e.g., number of items acquired by the group) and its log information, and
(8) The total number of the nth parameter of the group (e.g., the number of victories over other groups as a group) and its log information.

It is preferable that the log information regarding the total number of parameters for each player in the group include, for example, the added parameter values and their player IDs, and the time of the addition (time stamp). This enables identifying the player who provided the parameter values that reached the predetermined grant condition (the player who performed the action that satisfied the predetermined grant condition) when the total number of parameters (total value) reached the predetermined grant condition. Alternatively, it enables identifying the top several players who contributed the most to meeting the predetermined grant condition by searching the log information in order of the parameter values provided.

The log information on the total number of parameters in the group may include, for example, the parameter values added and the time of the addition (time stamp).

The groups can be formed in various ways according to the nature of each group, such as when plural players gather at the start of a game, when plural players gather during game play such as in a quest game, when an event or raid occurs, or when attributes such as the location of players are employed.

The timing of when a player belongs to each group can vary, such as when a player belongs to the group from the beginning or in the middle of the game. The player may leave the group in the middle of the game. In calculating the total amount of each player's parameters, if a player belongs to a group in the middle of the game, the parameters possessed by that player may be added to the total number of parameters, and if a player leaves the group in the middle of the game, the parameters possessed by that player may be subtracted from the total number of parameters. A player may belong to two or more different groups at the same time, as long as there are no specific constraints or inconsistencies in the game. For example, a player may belong to a specific team (Group 1) while also belonging to a group in his/her locality (Group 2).

The number of parameters (1 to n) related to the total number of parameters of each player in the group and the number of parameters (1 to n) of the group, which are stored and managed in the group information storage unit 124, can be appropriately set.

Among the above information, the total number (total value) of each of the first through nth parameters of each player in a group is acquired by the group information management unit 114, where the group information management unit 114 refers to the player information of each player stored in the player information storage unit 122 based on the ID of each player stored in the player ID of the group information table; refers to the game medium information stored in the game medium information storage unit 123 associated with each player ID; and sums the values of the target parameters of each player.

The privilege information storage section 125 stores, for each parameter stored in the group information storage unit 124, the conditions for granting, the contents of the privileges to be granted when the conditions for granting are satisfied, and the persons to whom the privileges are granted, being associated with each other. In the privilege information storage unit 125, for each of the plural parameters whose total number of values are stored in the group information storage unit 124, the conditions for granting, the contents of the privilege, and the persons to whom the privilege is granted are set. For example, the granting conditions, the privilege contents, and the grantees associated with each parameter are initially set in the game system, and each parameter can be individually set or changed in the server device 1 by an operation administrator of the game system. In particular, the privilege contents and the grantees associated with each parameter can be set for each event or raid.

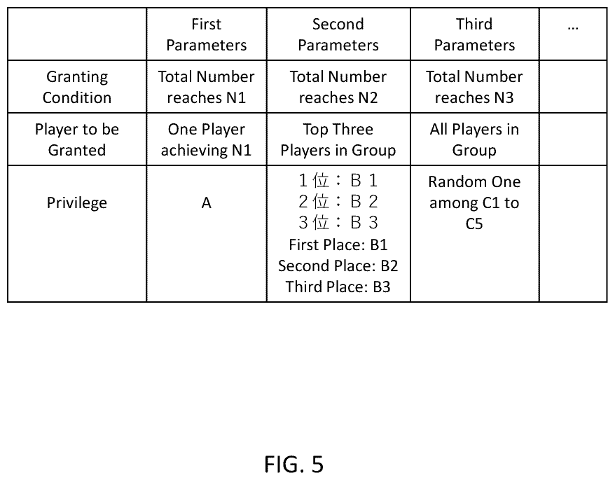

FIG. 5 shows an example of the configuration of the privilege information stored in the privilege information storage unit 125. Referring to the example shown in FIG. 5, below will be explained,
(1) For the first parameters, when the total number thereof reaches N1, the privilege “A” is granted only to those players who have achieved the total number of N1,
(2) For the second parameters, when the total number thereof reaches N2, the top three players in the group for that parameter are granted the privilege “31” for the first place player, “B2” for the second place player, and “B3” for the third place player, and
(3) For the third parameter, when the total number thereof reaches N3, one of the privileges “C1” to “C5” is set to be randomly granted to all players in the group.

In this example, for example, the first parameter (#1) may be the first parameter of each player in the group (e.g., number of characters owned), the second parameter (#2) may be the second parameter of each player in the group (e.g., number of items owned), and the third parameter (#3) may be the total number of first parameters (e.g., number of items owned by the group).

The conditions for granting, the content of the privilege, and the grantees associated with each parameter are not limited to the above examples. In addition to the above example, for example, in the example of the second parameter above, the number of grantees can be set to an arbitrary number, such as the top 10, and different privileges may be granted to each of those grantees, or the same privileges may be granted uniformly. Furthermore, the total number of granting conditions may be a random number within a certain numerical range, or the number of grantees may be a predetermined percentage of the number of persons in a group (e.g., two persons in a group of 20 persons, with a predetermined percentage of 10%). The granting conditions, privilege contents, and grantees associated with the parameters may be set individually for each parameter.

The server device 1 may hold the information included in these game information, player information, and game media information in a predetermined configuration as a storage unit, and need not necessarily hold the information as each storage unit 121 to 125 as described above.

The input unit 13 is for inputting various data (e.g., game information, etc.) relating to the game service by the system administrator, and is realized by, for example, a keyboard and mouse, or the like.

The display unit 14 is for displaying an operation screen for the system administrator based on a command from the control unit 11, and is realized by, for example, a liquid crystal display (LCD).

The communication unit 15 is for communicating with the player terminal 2 via the network 3, and has the function as a receiving unit for receiving various data, signals, and commands transmitted from the player terminal 2, and the function as a transmitting unit for transmitting various data and signals to the player terminal 2 according to commands from the control unit 11. The communication unit 15 communicates with the player terminal 2 using, for example, HTTP (Hyper Text Transfer Protocol), HTTPS, WebSocket, P2P (Peer to Peer), or the like.

### <Player Terminal 2>

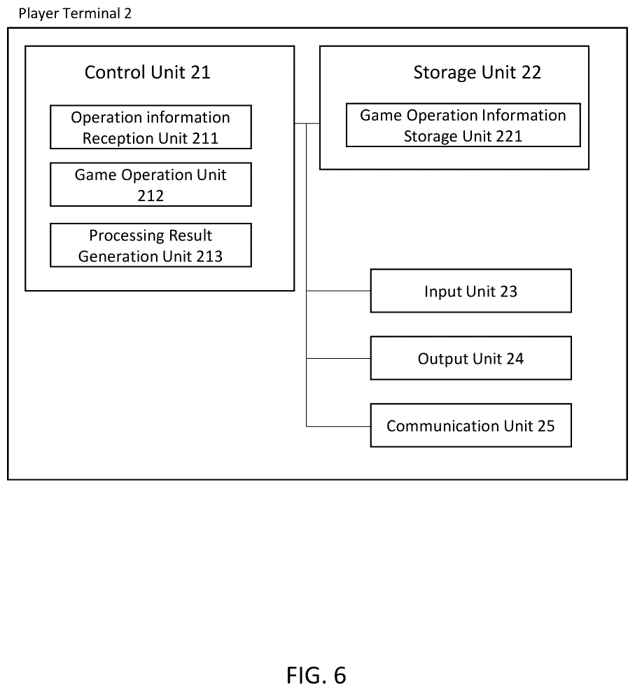

FIG. 6 is a block diagram showing the functional configuration of the player terminal 2 shown in FIG. 1. The player terminal 2 is an information processing device that the player can possess and use (for example, a smart phone, a mobile phone terminal, or a tablet terminal). The player terminal 2 can output (for example, game screen display, game sound output, etc.) the processing result of the game program transmitted from the server device 1 via a game application or a web browser. The player terminal 2 has a control unit 21 for controlling the entire player terminal 2, a storage unit 22 for storing various data and programs, an input unit 23 for the player to perform operation input, an output unit 24 for outputting game screens, operation screens, etc., and a communication unit 25 for performing information communication with the server device 1.

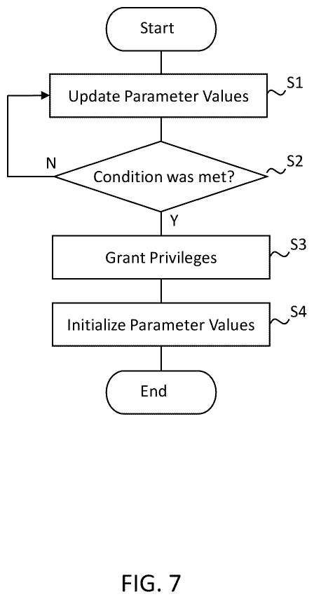

The control unit 21 controls the overall operation of the player terminal 2 by executing programs stored in the storage unit 22, and is composed of a CPU, a GPU, and the like. The control unit 21 of the present embodiment is configured to operate so as to implement the processing and its functions performed by the player terminal 2 as described with reference to FIG. 7.

The storage unit 22 stores programs, input data, and the like for executing various control processes and functions in the control unit 21, and is composed of one or any combination of RAM, ROM, flash memory, HDD, SSD, and other storage. The storage unit 22 temporarily stores the communication contents of the server device 1. The storage unit 22 of the present embodiment stores a program that causes the control unit 21 to execute processing performed by the player terminal 2, which will be described with reference to FIG. 7.

The control unit 21 of the present embodiment includes at least an operation information reception unit 211, a game operation unit 212, and a processing result reception unit 213. The storage unit 22 also includes at least a game operation information storage unit 221. Each functional unit of the control unit 21 can be realized by the CPU executing a program stored in the memory or the game operation information storage unit 221.

The operation information reception unit 211 in the player terminal 2 receives an operation related to the game by the player. The operation information reception unit 211 receives an operation related to the game using the input unit 23 by the player. Then, the operation information reception unit 211 outputs the received operation contents to the game operation unit 212 or the server device 1.

The game operation unit 212 executes processing for operating the game application. The game operation unit 212 operates the game based on the game software included in the game operation information stored in the game operation information storage unit 221 and the operation contents of the player inputted from the input unit 23. The game operation unit 212 generates an image for the game from the image data included in the game operation information in accordance with the game operation, and performs control processing for outputting the generated image to the output unit 24. Similarly, the game operation unit 212 generates game music and sound from the music data and sound data included in the game operation information in accordance with the game operation, and causes the output unit 24 to output the generated music and sound. Here, the description has been given on a configuration in which a native application partially executes the function of a web application, that is, the game operation unit 212 of the player terminal 2 partially executes the function of the server device 1; another configuration may be available that the server device 1 generates, without the game operation unit 212, all the images and sounds for the game as the processing result, or further another configuration may be available that the game operation unit 212 generates all the images and sounds for the game.

In the case of having the game operation unit 212, the predetermined parameters in the game operated by the game operation unit 212 may be managed by the server device 1. For example, parameters such as stamina and paid point in the game are managed by the server device 1. Therefore, the game operation unit 212 updates parameters managed by the server device 1 by communicating with the server device 1 if the game involves a process involving changes in these predetermined parameters. Then, the game operation unit 212 receives the updated parameters from the server device 1 and continues the game operation based on the updated parameters.

If the server device 1 has the processing result generation unit 113, the processing result reception unit 213 operates to receive the processing result generated and transmitted by the processing result generation unit 113 and output it to the player via the output unit 24.

The game system in the embodiment relates to a configuration in which the server device 1 manages the values of one or more parameters of each group composed of plural players, and grants predetermined privileges to predetermined players in the group when the value of the parameters reaches a predetermined threshold value. An example of basic operation of the game system in the embodiment will be described below with reference to FIG. 7.

FIG. 7 is a flow diagram illustrating an example of the basic operation of the system in the embodiment.

The group information management unit 114 of the server device 1 updates the values of the respective parameters associated with each group stored in the group information table illustrated in FIG. 4, which is stored in the group information storage unit 124, during operation of the game system (i.e., during execution of game-related processes between the server device 1 and the player terminals 2) (step S1).

The values of the parameters associated with each group that are updated by the group information management unit 114 include the total number of parameters (total value) for each player in the group and the value of the parameters managed as a group.

First, a description will be made that the group information management unit 114 updates the total number of parameters (total value) for each player in a group.

As described with reference to FIG. 4, the group information storage unit 124 stores, by associating with each group ID, the player IDs of the players in the group. Based on each player ID associated with a certain group ID, the group information management unit 114 refers to the player information stored in the player information storage unit 122 and associated with each player ID, and further refers to the game medium information stored in the game medium information storage unit 123 and associated with each player ID.

The group information management unit 114 acquires the values of the parameters (e.g., number of items owned) whose values are managed in the group information storage unit 124 from the game medium information and player information of each player thus referenced; and stores the total number of values acquired by summing those values obtained for each player, in the corresponding column of the group information table stored in the group information storage unit 124 and shown in FIG. 4. If the parameter is “Player Parameter #1” in the group information table shown in FIG. 4, the value of the total number is stored in the column associated with that parameter.

The group information management unit 114 performs the update process described above for each of the first through nth parameters of each player in each group. As described above, the group information table shown in FIG. 4 of the group information management unit 114 includes, for example, the added parameter values, their player IDs, and the time of addition (time stamp) as log information regarding the total number of parameters for each player in the group. This enables identifying the player who is the subject of the specific grant in the process described below.

The value of each player's respective parameter can change from moment to moment as the game progresses. For example, if a player's level increases as the game progresses, the value of that player's parameter increases, or if an item is acquired, the parameter value of the number of items owned and the parameter value of the number of items acquired increase. As described above, in the processing results generated by the processing result generation unit 113, if there is a change in the player information stored in the player information storage unit 122 or in the game medium information stored in the game medium information storage unit 123, the processing result generation unit 113 will change the player information or the game medium information stored in those storage units 122, 123; therefore, If there is a change in the value of a player's parameter, the value of the parameter in the player information or the game medium information associated with the player ID of the player is updated.

Thus, the values of the parameters in the player information or in the game media information associated with a player's player ID are updated by the processing result generation unit 113 at any time. Therefore, if the updating process of the total parameter values of each player in a group by the group information management unit 114 is performed in a timely manner for that group at the timing when the processing result generation unit 113 updates any player information or any game media information stored in the storage units 122, 123, the updating process of the total value of the parameter values of each player can be executed while reflecting the changes in the parameter values of each player in practically real time. Alternatively, from the viewpoint of reducing the processing burden of the group information management unit 114, the updating process of the total parameter values of each player in the group by the group information management unit 114 may be executed at a fixed time interval (e.g., every few seconds, every few minutes, every few hours, etc.).

Next, an explanation will be given that the group information management unit 114 updates the values of the parameters managed as a group.

As explained with reference to FIG. 4, the group information storage unit 124 stores the values of one or more parameters managed as a group in association with each group ID. As described above, the one or more parameters managed as a group are, for example, the number of items owned by the group, the number of items acquired by the group, the number of battles and victories to other groups.

If the processing results generated by the processing result generation unit 113 include, for example, that a group has newly acquired items as a group, the group information management unit 114 updates to increase the value of the group parameter regarding the number of items acquired by the group in the group information table shown in FIG. 4 and stored in the group information storage unit 124.

The group information management unit 114 performs the update process described above for each of the first through nth group parameters for each group.

The privilege granting unit 115 of the server device 1 then judges (step S2) whether or not the conditions have been met (the predetermined threshold has been reached) for each of the predetermined conditions set for the respective parameter of each group, based on the group information table shown in FIG. 4 and stored in the group information storage unit 124.

As described above with reference to FIG. 5, the privilege information storage unit 125 stores, for each parameter stored in the group information storage section 124, privilege information that associates a condition for granting, the content of the privilege to be granted if the condition for granting is satisfied, and the person to whom those privileges are granted. The privilege granting unit 115 refers to and compares the total value of the parameters to be judged in the group information table in the group information storage unit 124 with the granting conditions for the parameters to be judged in the privilege information stored in the privilege information storage unit 125, and judges whether or not the total value of the parameters to be judged satisfies the granting conditions.

For example, if the parameter to be judged is the first player parameter (number of items owned) shown in FIG. 4; the total value of the parameters is 10 at the time of judgment; and the granting condition is set to “total number 10 or more” for the first player parameter (number of items owned) shown in FIG. 5, the privilege granting unit 115 compares the total value of the first player parameter “10” and the threshold value “10” of the granting condition associated with that parameter to judge that the total value of the parameter meets the granting condition.

The privilege granting unit 115 performs the judgment process in step S2 for each parameter stored in the group information storage section 124. This judgment processing may be performed for parameters whose values were updated in step S1 above at the timing when the update processing is performed, or it may be performed at a fixed time interval for each parameter (e.g., at intervals of a few seconds, minutes, hours, etc.).

When the privilege granting unit 115 judges that the total value of the parameter for which the privilege grantee is limited meets the grant condition (Y), the group information management section 114 identifies the player ID of the target player to whom the privilege should be granted for that parameter.

For example, if the total value for the first parameter of the privilege information shown in FIG. 5 meets the conditions for granting, since only the player who has achieved the total number is eligible for the privilege, the group information management unit 114 identifies the player ID of the player who has achieved the total number as the eligible for the privilege by referring to the log information on the total value for that parameter stored in the group information storage unit 124.

If the total value for the second parameter of the privilege information shown in FIG. 5 meets the conditions for granting, since only the top three players are eligible for the privilege, the group information management unit 114 identifies the player IDs of the three players in order of the highest value for that parameter by referring to the log information of the total value for that parameter stored in the group information storage unit 124.

If it is judged in step S2 that the total value of the parameters meets the grant condition (Y), the process proceeds to step S3. On the other hand, if it is judged that the total value of the parameters does not meet the granting condition (N), the process returns to step S1.

If it is judged in step S2 that the total value of the parameters meets the conditions for granting (Y), the privilege granting unit 115 executes a process to grant a predetermined privilege to a predetermined target person by referring to the privilege information stored in the privilege information storage unit 125 (step S3).

As an example, if in the above example, the parameter to be judged that the total value of the first player parameter (number of items owned) shown in FIG. 4 meet the grant conditions, the predetermined privilege “A” is granted to the top one player in the group who is the grantee set in the privilege information shown in FIG. 5 related to the first player parameter.

Finally, the group information management unit 114 of the server device 1 initializes the values of some of the parameters for which privilege granting was executed by the privilege granting unit 115 in step S3 in the group information table stored in the group information storage unit 124 and illustrated in FIG. 4 (step S4).

Consequently, the value of the parameter for which the privilege has been granted once is reset, and if the grant condition is subsequently met again by processing steps S1 to S3 described above, the privilege associated with that parameter is granted again. For example, it is possible to initialize the values of parameters that can be counted repeatedly after being reset, such as the number of items acquired, the number of items consumed, the amount of paid or free in-game currency spent, the number of points acquired, and the number of lotteries performed.

Through the above process, privileges are granted to a predetermined player in a group under predetermined conditions.

Thus, according to the embodiment, the game system provides a configuration that an in-game privilege is granted to a predetermined player when certain conditions are achieved as a result of the aggregation of the activities of each player in a certain group.

For the purpose of acquiring such privileges, players are required to belong to any group in the game, play the game as a member of that group, and contribute to increasing one or more parameters (such as the number of items owned) of that group. In addition, since the opportunity to acquire privileges increases by playing the game as a member of plural groups, players can be motivated to belong to plural groups and play the game continuously as a member of each group.

Furthermore, in the privilege granting configuration provided by this system, whether or not a player satisfies the conditions for granting privileges depends not only on the player's own parameter values, but also on the parameter values of other players in the group. Therefore, since there is no predictability as to which player will fulfill the conditions for granting privileges and when the privilege will be granted, each player can have the expectation that the privilege may be granted to him or her. From this perspective, it is also possible to provide players with an incentive to continue playing the game.

Next, various examples of the embodiments will be described.

### Example 1

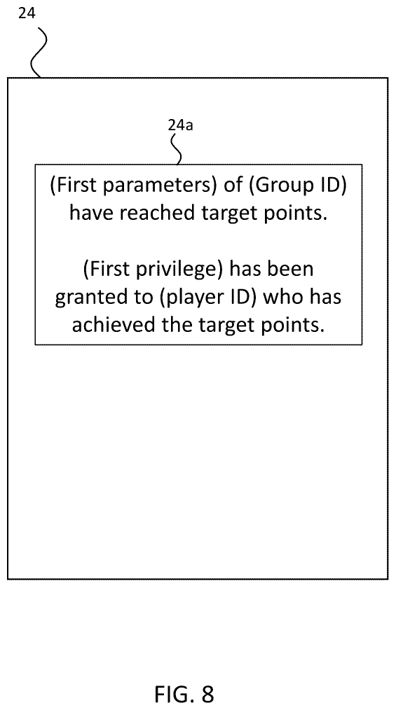

FIG. 8 shows an example of the configuration of the screen of the player terminal.

In this example, a message screen 24a displaying a message that the privilege was granted is displayed on the output unit (display screen) 24 of the player terminal 2 operated by the player to whom the privilege was granted by the privilege granting unit 115 according to step S3 shown in FIG. 7.

When the privilege granting process is executed by the privilege granting unit 115 (step S3 in FIG. 7), the processing result generation unit 113 generates a message as a result of the privilege granting process, which informs the player ID of the player to whom the privilege was granted, which target total of number of parameters was satisfied by action and what privilege was granted as the result. When the privilege granting process by the privilege granting unit 115 is executed, since it was specified which is the play ID, which target total of number of parameters was satisfied by action, and what privilege was granted as the result, the processing result generation unit 113 generates a message based on that identified information and sends the message information to the player terminal 2 that is the target of the notification and operated by the player's player ID.

The player terminal 2 that has received the message information displays the message screen 24a displaying the message on the output unit 24. The message shown in FIG. 8 is an example and can have different contents depending on the grantee and grant conditions. For example, if the privileges are granted to the top several players, the content may be “the privilege B2 was granted to you who is second in ranking of contribution to target point achievement,” or “the privileges B1, B2, and B3 were respectively granted to Mr. X, Mr. Y, and Mr. Z, who are third in ranking of contribution to target point achievement.”

The above example shows that the message is notified only to the subject to whom the privilege is granted; however, the message may be notified to all players in the group after the privilege granting process is completed.

Thus, by notifying the player to whom the privilege has been granted or all the players in the group of the message that the privilege has been granted, those players will know that the privilege grant for the parameter associated with the privilege (e.g., the number of items owned) has been completed.

### Example 2

This example provides a means of notifying each player in the group of a warning message, for example, “you needs xxx points for being granted the privilege of the number of items acquired” when the total value of certain parameters of the group approaches the privilege condition.

As described in step S2 of FIG. 7, when the privilege granting unit 115 judges whether or not the predetermined conditions set for each parameter of each group have been met (i.e., whether or not the predetermined threshold has been reached), the privilege granting unit 115 refers and compares the total value of the parameters to be judged that are stored in the group information table of the group information storage unit 124 with the privilege conditions for the parameters to be judged in the privilege information stored in the group information storage unit 125. At this time, if the privilege granting unit 115 judges that the total value of the parameters to be judged does not meet the grant condition, the privilege granting unit 115 can calculate the difference between the total value of the parameters to be judged and the value of the grant condition, thereby generating information indicating how much more the total value must increase to meet the grant condition.

Therefore, for example, by setting in advance for each parameter in the privilege information shown in FIG. 5, which value of the difference between the total value and the granting condition is to be notified with a warning message, when the above difference value calculated by the privilege granting unit 115 reaches the above set value, the processing result generation unit 113 can send the warning message to the player terminals 2 of all players in the group, for example.

A player who receives such a notification may, as an example, increase the total value of the parameters for the group by increasing his or her own parameter value for the number of items acquired, thereby knowing that the likelihood of being granting a privilege is increasing as a result; therefore, the player may continue the action of increasing his or her own parameter value to acquire items. Thus, players can be provided with an incentive to continue playing the game.

### Example 3

The above mentioned embodiment discloses the case where the total number of parameters (total value) exceeds a certain threshold value as set in the privilege information in FIG. 5 as a condition for granting; the conditions for granting are not limited thereto.

In addition to “when the total number of parameters (total value) exceeds a certain value” as described above, “all players in the group each have at least a predetermined value for the parameter” may be specified as a condition for granting the privilege.

This prevents the players who contribute to the achievement of the granting conditions for that parameter from being biased toward some players in the group, and requires all players in the group to make a certain level of contribution. Therefore, each player in the group will be more active in the game, and each player's game playing time can be longer as a result.

In the embodiments and variations described above, the player terminal 2 may be equipped with some or all of the functions of the server device 1 to the extent that the purpose of the present disclosure can be realized with respect to the processing of software functions provided by the server device 1 and the player terminal 2.

The process in FIG. 7 is an example of processing by the information processing system and is not intended to limit the present disclosure. The processes included in FIG. 7 may be executed in a different order than shown in the figure, some processes may be executed in parallel, some processes may be omitted, or other processes may be added.

The above embodiments are merely examples to facilitate understanding of the disclosure and are not intended to be construed as limiting the disclosure. The disclosure may be changed and improved without departing from its purpose, and that the disclosure includes its equivalents.

### DESCRIPTION OF REFERENCE NUMERALS

1: server device (game server)
2: player terminal
3: network

1. A game server comprising:
a group information management unit that manages one or more values of one or more parameters associated with a group that includes a plurality of players; and
a privilege granting unit that when the one or more values of the one or more parameters satisfies a predetermined conditions, grants predetermined in-game privileges only to one or more players that have performed actions that satisfy the predetermined conditions, in the group associated with the one or more parameters.

2. The game server according to claim 1, wherein the group information management unit updates the one or more parameters in common in the group based on a behavior of one of the plurality of players in the group

3. The game server according to claim 1, wherein the predetermined condition includes that a sum of the one or more values of the one or more parameters of each of the plurality of players in the group reaches a predetermined value.

4. The game server according to claim 3, wherein the privilege granting unit grants the predetermined in-game privileges to a predetermined number of the plurality of players in order of their contribution to a sum of the one or more values of the one or more parameters.

5. The game server according to claim 1, wherein the predetermined conditions, the predetermined in-game privileges, and the one or more players that are granted the predetermined in-game privileges are set individually for each of the one or more parameters.

6. A game program that allows a computer to implement:
managing one or more values of one or more parameters associated with a group that includes a plurality of players; and
when the one or more values of the one or more parameters satisfies a predetermined conditions, granting predetermined in-game privileges only to one or more players that have performed actions that satisfy the predetermined conditions, in the group associated with the one or more parameters.

7. An information processing method by using a computer, comprising:
managing one or more values of one or more parameters associated with a group that includes a plurality of players; and
a privilege granting unit that when the one or more values of the one or more parameters satisfies a predetermined conditions, granting predetermined in-game privileges only to one or more players that have performed actions that satisfy the predetermined conditions, in the group associated with the one or more parameters.
